(19) United States
(12) Patent Application Publication
(10) Pub. No.: US 2024/0220888 A1
(43) Pub. Date: Jul. 4, 2024

(54) SCHEDULING FOR HEAVY EQUIPMENT USING SENSOR DATA

(71) Applicant: University of Utah Research Foundation, Salt Lake City, UT (US)

(72) Inventors: Behnam Sherafat, Salt Lake City, UT (US); Abbas Rashidi, Salt Lake City, UT (US); Armin Tajalli, Salt Lake City, UT (US)

(21) Appl. No.: 18/475,627

(22) Filed: Sep. 27, 2023

Related U.S. Application Data
(60) Provisional application No. 63/435,948, filed on Dec. 29, 2022.

(51) Int. Cl. G06Q 10/0631; G06Q 50/08

(52) U.S. Cl. CPC G06Q 10/06312; G06Q 50/08

(57) ABSTRACT

Disclosed systems and methods create a schedule by a scheduling software. The scheduling software receives a project or certain activities that includes information that describes requirements of the project or certain activities. The scheduling software also receives a dataset of available heavy equipment associated with the project or certain activities and selects a set of heavy equipment from the dataset of available heavy equipment. Each heavy equipment includes at least one sensor and sensor data is received from the sensor(s) for each heavy equipment. The scheduling software maps the sensor data to a profile. The profile characterizes a machine learning algorithm for at least one heavy equipment selected from the set of heavy equipment and outputs a set of productivity rates for at least a portion of the set of heavy equipment. The scheduling software automatically updates the schedule based on the set of productivity rates.

### CROSS-REFERENCE TO RELATED APPLICATIONS

This application claims priority to, and the benefit of, U.S. Provisional Application Ser. No. 63/435,948, filed Dec. 29, 2022 and entitled “SENSORS FOR HEAVY EQUIPMENT,” the entire contents of which are incorporated by reference herein in their entireties.

### GOVERNMENT RIGHTS

This invention was made with government support under grant 2016514 awarded by the National Science Foundation. The government has certain rights in this invention.

### BACKGROUND

Heavy construction equipment is used for executing many construction tasks, especially in earth-working operations. A significant part of the total budget for medium-sized and large-sized industrial or residential projects comprises equipment rental, owning, and maintenance costs. Thus, constantly monitoring construction equipment operations can help maintain the pace of construction activities, discover potential issues and obstacles, prevent those issues, and reduce the project cost. The traditional method of monitoring construction equipment operations includes analyzing production rates and conducting performance assessments through direct observations such as work sampling and method productivity delay model, interviews, foremen/craftsman surveys, and crew-balance charting. All these manual monitoring methods could be time-consuming, error prone, costly, and not applicable for larger job sites where several equipment operations are simultaneously ongoing. Therefore, there is a need in the construction industry for an automated equipment performance monitoring system capable of collecting and analyzing performance data such as equipment/operator productivity rates and then updating construction schedules and providing feedback and corrective decisions in real-time (or near real-time) settings.

The subject matter claimed herein is not limited to embodiments that solve any disadvantages or that operate only in environments such as those described supra. Instead, this background is only provided to illustrate one example technology area where some embodiments described herein may be practiced.

### SUMMARY

In some aspects, the techniques described herein relate to a computer implemented method, including: creating a schedule by a scheduling software, wherein creating the schedule includes: receiving a project or certain activities, wherein the project or certain activities includes a set of information that describes requirements of the project or certain activities; receiving a dataset of available heavy equipment associated with the project or certain activities; selecting a set of heavy equipment from the dataset of available heavy equipment, wherein each heavy equipment in the set of heavy equipment includes at least one sensor; receiving sensor data from the at least one sensor for each heavy equipment in the set of heavy equipment; mapping the sensor data to a profile, wherein the profile characterizes a machine learning algorithm for at least one heavy equipment selected from the set of heavy equipment; outputting a set of productivity rates for at least a portion of the set of heavy equipment; automatically updating the schedule by the scheduling software based on the set of productivity rates.

In some aspects, the techniques described herein relate to a computer system, including: a processor system; and a computer storage medium that stores computer-executable instructions that are executable by the processor system to at least: receive a project or certain activities, wherein the project or certain activities includes a set of information that describes requirements of the project or certain activities; receive a dataset of available heavy equipment associated with the project or certain activities; select a set of heavy equipment from the dataset of available heavy equipment, wherein each heavy equipment in the set of heavy equipment includes at least one sensor; receive sensor data from the at least one sensor for each heavy equipment in the set of heavy equipment; map the sensor data to a profile, wherein the profile characterizes a machine learning algorithm for at least one heavy equipment selected from the set of heavy equipment; output a set of productivity rates for at least a portion of the set of heavy equipment; automatically update a schedule based on the set of productivity rates.

In some aspects, the techniques described herein relate to a computer storage medium that stores computer-executable instructions that are executable by a processor system to create a schedule, the computer-executable instructions including instructions that are executable by the processor system to at least: receive a project or certain activities, wherein the project or certain activities includes a set of information that describes requirements of the project or certain activities; receive a dataset of available heavy equipment associated with the project or certain activities; select a set of heavy equipment from the dataset of available heavy equipment, wherein each heavy equipment in the set of heavy equipment includes at least one sensor; receive sensor data from the at least one sensor for each heavy equipment in the set of heavy equipment; map the sensor data to a profile, wherein the profile characterizes a machine learning algorithm for at least one heavy equipment selected from the set of heavy equipment; output a set of productivity rates for at least a portion of the set of heavy equipment; automatically update the schedule based on the set of productivity rates.

This Summary introduces a selection of concepts in a simplified form that are further described below in the Detailed Description. This Summary is not intended to identify key features or essential features of the claimed subject matter, nor is it intended to be used to determine the scope of the claimed subject matter.

### BRIEF DESCRIPTION OF THE DRAWINGS

To describe how the advantages of the systems and methods described herein can be obtained, a more particular description of the embodiments briefly described supra is rendered by reference to specific embodiments thereof, which are illustrated in the appended drawings. These drawings depict only typical embodiments of the systems and methods described herein and are not, therefore, to be considered to be limiting in their scope. Systems and methods are described and explained with additional specificity and detail through the use of the accompanying drawings, in which:

FIG. 1 illustrates an example of a project or of certain activities and available heavy equipment and operators;

FIG. 2 illustrates an example of a computer architecture that facilitates creating a schedule;

FIG. 3 illustrates an example machine learning model;

FIG. 4 illustrates a flow chart of an example of a method for creating a schedule; and

FIG. 5 illustrates a flow chart of an example of a method for outputting productivity rates.

### DETAILED DESCRIPTION

Embodiments of the present invention generally relate to a scheduling software that uses productivity rates to update a schedule for construction projects or certain activities related to construction. More particularly, at least some embodiments of the invention relate to systems, hardware, software, computer-readable media, and methods for creating and updating a schedule based on productivity rates associated with heavy equipment assigned to a construction project.

In general, example embodiments provide a robust Internet of Things (IoT) based system for monitoring heavy construction equipment operations using sensors attached to the equipment bodies. Disclosed embodiments further provide sensor(s) (e.g., a kinematic and/or acoustic sensor(s)) that collects data from each piece of equipment, wirelessly sends the data to a central unit in a project office, and stores the data in a database for further analysis. In addition, disclosed embodiments provide a scheduling software that automatically outputs equipment productivity rates and updates projects or certain activities schedules.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, an embodiment may enable a database that includes profiles of commonly used construction heavy equipment. The database may be enriched gradually to cover all commonly used heavy equipment and machine learning models associated with the heavy equipment and therefore improving the accuracy of the productivity rates. An embodiment may also train machine learning models to further improve the accuracy of determining productivity rates associated with different types of heavy equipment and operators of the heavy equipment. Thus, disclosed embodiments are an appealing tool for the construction industry, and specifically for earth-moving operations. Embodiments may assist project managers in automatic equipment performance monitoring and schedule updating based on project-specific information.

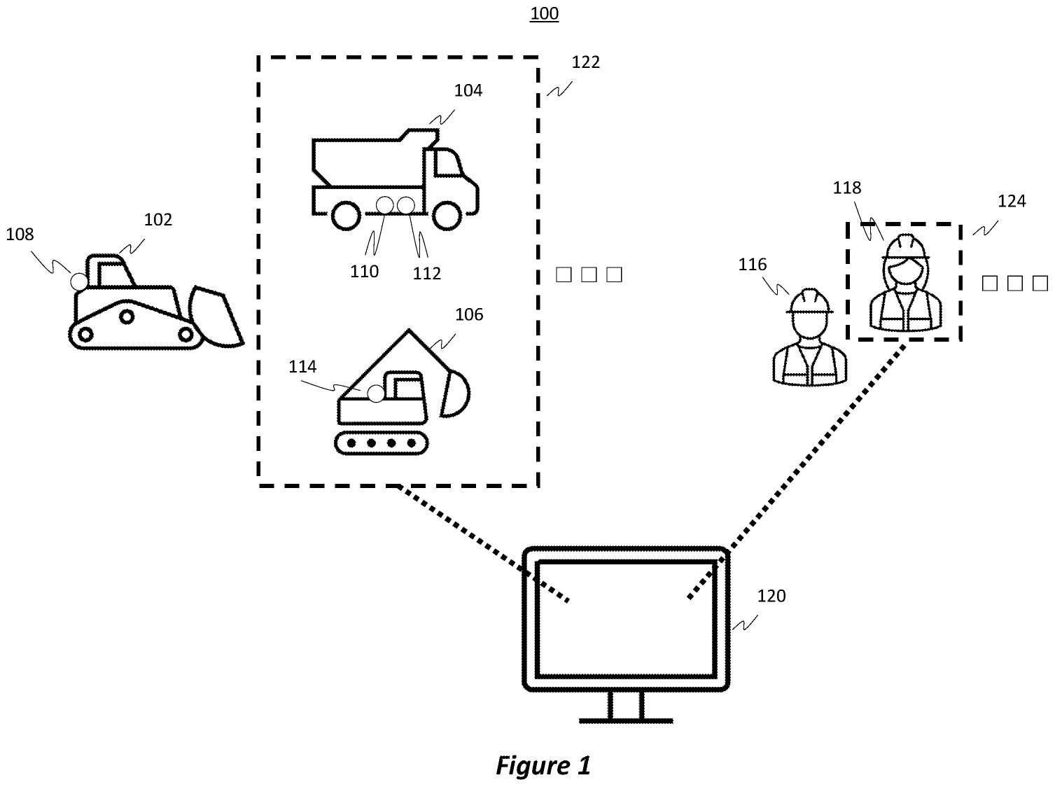

FIG. 1 illustrates an example of resources available for a project or of certain activities that are used by a computing system to create a schedule. As shown in FIG. 1, a project or certain activities has heavy equipment 102, heavy equipment 104, and heavy equipment 106 available. As an example, heavy equipment 102 is a bulldozer, heavy equipment 104 is a dump truck, and heavy equipment 106 is an excavator.

In some embodiments, the heavy equipment may include excavators, graders, skid-steer loaders, wheel tractor-scrapers, backhoe loaders, dragline excavators, bulldozers, backhoes, cranes, telescopic handlers, dump trucks, pavers, tower cranes, loaders, compactors, trenchers, trucks, forklifts, feller bunchers, tractors, compact excavators, or other heavy construction equipment. In some embodiments, the heavy equipment is categorized with an equipment type (e.g., standard, wheeled, long-reach, or backhoe excavator). In some embodiments, the heavy equipment is categorized as more than one equipment type (e.g., a standard and a backhoe excavator).

Each piece of heavy equipment each has at least one sensor. For example, FIG. 1 shows heavy equipment 102 having a single sensor 108, heavy equipment 104 having a first sensor 110 and a second sensor 112, and heavy equipment 106 having a single sensor 114. In some embodiments, each heavy equipment has the same number of sensors. In other embodiments, the number of sensors on each heavy equipment varies. In yet other embodiments, each heavy equipment may have one, two, three, four, five, or more than five sensors.

As an example embodiment, the sensor 108 on heavy equipment 102 and the sensor 114 on heavy equipment 106 both include a microphone and an accelerometer. In the case of heavy equipment 104, the first sensor 110 is a microphone and the second sensor 112 is an accelerometer. In some embodiments, a single sensor may include accelerometers, gyroscopes, a microphone, an array of microphones, other kinematic and audio sensors, or a combination thereof. In some embodiments, multiple sensors may be used where each sensor may include accelerometers, gyroscopes, a microphone, an array of microphones, other kinematic and audio sensors, or a combination thereof.

FIG. 1 shows sensor 108 being placed on the back of heavy equipment 102, sensor 110 and sensor 112 being placed on the bottom of heavy equipment 104, and sensor 114 being placed on the top in the center of heavy equipment 106. Embodiments may determine an optimal sensor placement dependent on project, certain activities, type of heavy equipment, or other appropriate factors. In the case of multiple sensors (e.g., sensor 110 and sensor 112), the sensors may be placed together, as shown in FIG. 1, or may be separated (e.g., one sensor on the top of the heavy equipment and one sensor on the bottom of the heavy equipment). In some embodiments, the sensor(s) may be selectively coupled to the heavy equipment to allow for movement of the sensor(s) throughout the project or certain activities.

Additionally, the project or certain activities has operator 116 and operator 118 available. In some embodiments, operator 116 is assigned to heavy equipment 102 and operator 118 is assigned to heavy equipment 104 and heavy equipment 106. In some embodiments, the number of available operators is equal to the number of available heavy equipment. In other embodiments, an operator is assigned to multiple heavy equipment.

A computing system 120 that includes scheduling software receives the project or certain activities and the dataset of available heavy equipment associated with the project or certain activities. In some embodiments, the computing system 120 also receives the available operators. The computing system 120 selects a set of heavy equipment 122 from the available equipment (e.g., heavy equipment 104 and heavy equipment 106). In some embodiments, the computing system 120 also selects a set of operators 124 (e.g., operator 118). In some embodiments, the selected set of operators 124 may be based on the set of selected heavy equipment 122 (e.g., operator 118 is assigned to heavy equipment 104 and heavy equipment 106). In other embodiments, the selected set of operators 124 are chosen randomly. In some embodiments, the selected set of equipment 122 is selected based on the set of selected operators 124.

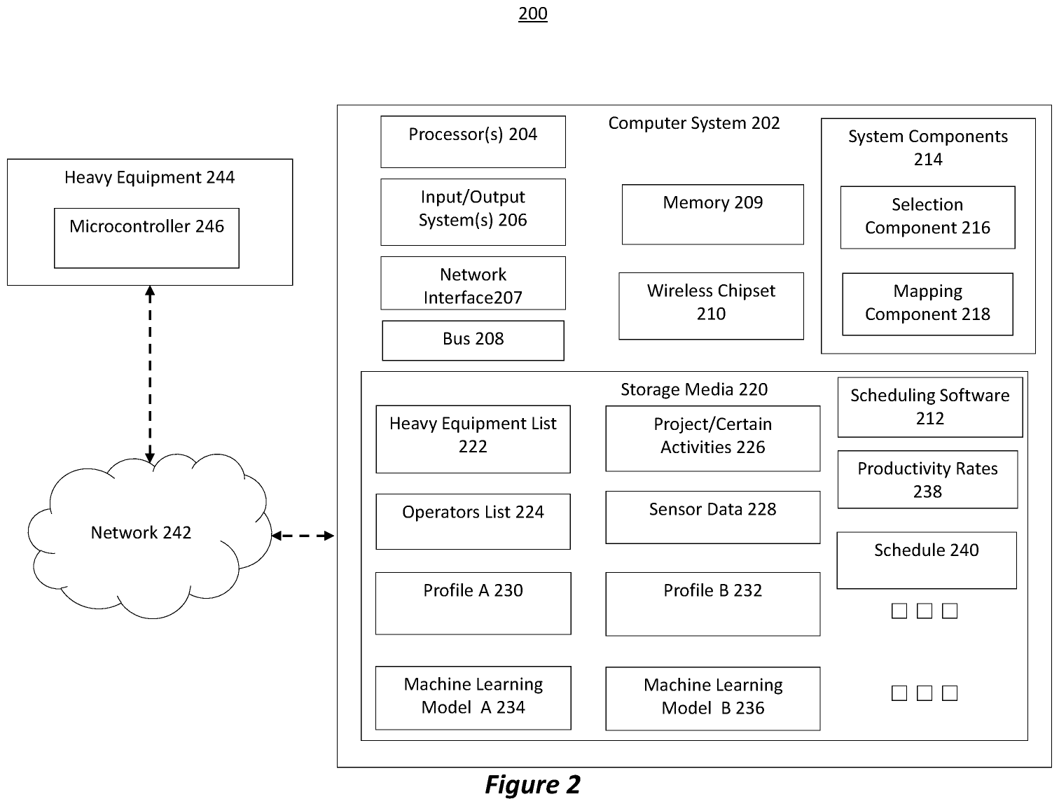

FIG. 2 illustrates an example of computer architecture 200 that facilitates creating a schedule. As shown, computer architecture 200 includes a computer system 202 comprising processor system 204 (e.g., a single processor or a plurality of processors), memory 209 (e.g., system or main memory), storage media 220 (e.g., a single computer-readable storage medium, or a plurality of computer-readable storage media), all interconnected by a bus 208. As shown, computer system 202 may also include a network interface 207 (e.g., one or more network interface cards) for interconnecting (via a network 242) to a computer system 202 (e.g., a single computer system or a plurality of computer systems) and to heavy equipment 244.

FIG. 2 illustrates storage media 220 as storing computer-executable instructions implementing at least creating a schedule by the scheduling software 212. Storage media 220 also includes the selected project or certain activities 226, heavy equipment list 222 which includes the available heavy equipment available for the project or certain activities 226, and operators list 224 assigned to the heavy equipment list 222.

FIG. 2 also illustrates system component 214 which includes a selection component 216 and a mapping component 218. The selection component 216 receives the project or certain activities 226. The project or certain activities 226 includes information describing the project or certain activities 226. Based on the information, the selection component 216 selects a set of heavy equipment from the heavy equipment list 222 that is associated with the project or certain activities 226. Additionally, the selection component 216 optionally selects a set of operators assigned to the selected heavy equipment from the operators list 224.

Each piece of heavy equipment in the selected set of heavy equipment includes at least one sensor, as shown in FIG. 1. Each sensor associated with the selected set of heavy equipment sends sensor data 228 to the computing system 202, which is stored in the storage media 220. As an example, heavy equipment 244 includes a microcontroller 246 which sends the sensor data 228 to the wireless chipset 210 in the computing system 202 via a network 242. In this example, the microcontroller 246 located within the heavy equipment 244 is configured to communicate with the wireless chipset 210 located within the computer system 202. In some embodiments, the microcontroller 246 communicates with the wireless chipset 210 via a wired connection between the heavy equipment 244 and the computer system 202. In other embodiments, the microcontroller 246 communicates with the wireless chipset 210 via Bluetooth or other wireless communications. In embodiments, the communication between the microcontroller 246 and the wireless chipset 210 is established using a serial/parallel interface (SPI) standard.

Once the sensor data 228 is stored in the computer system 202, the sensor data 228 may be ingested into a repository. In some embodiments, the sensor data 228 may also include metadata associated with the raw data from the sensors. In these embodiments, the metadata may include contextual information such as timestamps, location information, tags, identifiers, and other appropriate contextual information regarding the sensor data 228. In embodiments, the sensor data 228 and associated metadata may be organized based on the type of heavy equipment that generated the sensor data 228.

The system components 214 also includes a mapping component 218. The mapping component 218 receives the sensor data 228 and maps the sensor data 228 to one of the profiles (e.g., profile A 230, profile B 232, or another profile). Each profile (e.g., profile A 230 and profile B 232) characterizes a machine learning algorithm (e.g., machine learning model A 234 or machine learning model B 236). For example, profile A 230 is associated with machine learning model A 234 and profile B 232 is associated with machine learning model B 236. The machine learning algorithms are also associated to heavy equipment. As an example, profile A 230 which characterizes machine learning model A 234 is associated with the heavy equipment 244.

The mapping component 218, receives the sensor data 228 from heavy equipment 244 and maps the sensor data 228 to profile A 230. In more detail, the mapping component 218 may create a data profile for each piece of heavy equipment. The profiles for each heavy equipment may be created based on the sensor data 228 and metadata associated with the sensor data 228 including timestamps associated with the sensor data 228. By specifically creating profiles for each piece of heavy equipment, embodiments are able to create a complete history of sensor data 228 with relevant contextual information associated with the sensor data 228 including timestamp information about the sensor data 228. The complete history allows for tracking the behavior of each piece of heavy equipment and observe any anomalies.

As mentioned above, each profile is associated with a machine learning model. For example, profile A 230 characterizes machine learning model A 234 for heavy equipment 244. In some embodiments, the mapped profile and characterized machine learning model is associated to at least one heavy equipment in the selected set of heavy equipment. In other embodiments, the mapped profile and characterized machine learning model is associated to a type of heavy equipment and at least one of the heavy equipment in the selected set of heavy equipment is the associated type of heavy equipment.

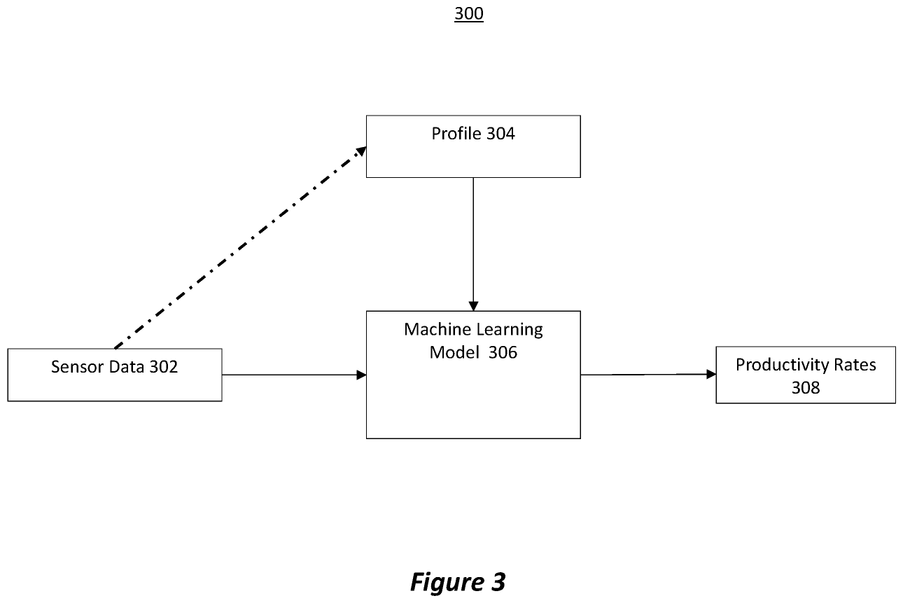

Turning to FIG. 3, the sensor data 302 (e.g., 228) is mapped to profile 304 (e.g., profile A 230) where the profile 304 characterizes a machine learning model 306 (e.g., machine learning model A 234). The sensor data 302 is inputted into the machine learning model 306. The machine learning model 306 outputs a set of productivity rates 308. The set of productivity rates 308 are stored (e.g., in storage media 220 as productivity rates 238) to be used to update a schedule (e.g., schedule 240). In some embodiments, the machine learning model is a convolutional neural network.

Returning to FIG. 2, the productivity rates 238 are outputted by the machine learning model characterized by the mapped profile. For example, the productivity rates 238 are outputted by machine learning model A 234 characterized by profile A 230 for heavy equipment 244 that generated sensor data 228.

In more detail, sound and/or kinematic patterns are extracted from the sensor data 228 using a beamforming technique. The beamforming technique is a method of spatial filtering or localization of desired sound from a variety of other unwanted sound sources in an environment. Beamforming algorithms are based on relative time delays between sound sources. In some embodiments, the beamformers is a wideband beamformer such as time-delay beamformer, sub-band phased shift beamformer, time-delay Linear Constraint Minimum Variance (LCMV) beamformer, frost beamformer, generalized side-lobe canceler (GSC) beamformer, or wideband Minimum-Variance Distortionless-Response (MVDR) beamformer.

In embodiments, the beamformer technique used to extract the sound and/or kinematic patterns from the sensor data 228 is determined by analyzing the microphone array design, beamwidth, frequency range, noise suppression, robustness, resources, performance metrics, or other factors. In more detail, the microphone array design significantly influences the beamforming performance. For example, depending on the size and geometry of the heavy equipment, a linear, planar, or spatial microphone array would be appropriate to effectively capture signals from specific directions. The beamwidth of the beamforming configuration determines the angular coverage within which the sensors can effectively capture sound. For example, a narrower beamwidth can isolate a specific source, however, may miss context. Conversely, a wider beamwidth may capture more ambient noise.

Some beamformer techniques are better suited for specific frequency ranges. For example, narrowband beamforming works well for high-frequency equipment sounds while broadband configurations are more suitable for capturing a wider range of frequencies. Additionally, the beamforming configuration will differ in its ability to suppress background noise and interference. The ability to suppress background noise affects the ability to accurately capture equipment specific sounds without noise contamination. The robustness of the beamforming configuration affects the ability to change the environment, position, or other variables of the heavy equipment. In some embodiments, a configuration that can adapt to multiple real-world applications may be preferred in some instances while a specific configuration for a specific project may be preferred in other instances.

In some embodiments, the computational resources required for the beamforming algorithm may be taken into account. Further, the computational resources that are available at particular points in time may be used to determine which beamforming algorithm to use. In some embodiments, computational resources may be chosen ahead of time based on the desired beamforming algorithm. In other embodiments, the beamforming technique may be chosen based on available computational resources at the time of data collection. Performance metrics may include signal-to-noise ratio (SNR), mean square error (MSE), or other relevant metrics. The different configurations of the beamformer may result in different performance metrics. Embodiments may evaluate performance metrics to determine optimal beamforming configurations.

Additionally, embodiments may perform iterative testing and validation testing. The iterative testing and validation testing may include deploying multiple different beamforming configurations to determine a preferable configuration based on the project. In some embodiments, a model may be used to determine the preferred beamforming configuration prior to being used. Based on the iterative testing and validation testing, adjustments to the beamformer may be performed. The adjustments may be performed in real-time, periodically, or randomly.

In some embodiments, the beamforming technique is adaptive and can be adjusted in real-time based on the incoming signals. In other embodiments, the beamforming may be fixed and remains relatively constant. Taking all of these into account, in some preferred embodiments, the beamformer technique is either a frost beamformer or a time-delay Linear Constraint Minimum Variance (LCMV) beamformer.

After the beamformer extracts sound and/or kinematic patterns, the sound and/or kinematic patterns are pre-processed. In one example embodiment, the pre-processing may include converting the sound and/or kinematic patterns into a set of images. In some embodiments, the sound and/or kinematic patterns are converted into a set of images by using a Short Time Fourier Transform. The set of images are input into the machine learning model (e.g., machine learning model A 234). In other embodiments, the sound and/or kinematic patterns are pre-processed using other methods to prepare the signals for the machine learning model. In some embodiments, the machine learning model is a convolutional neural network. In embodiments, the set of information relating to the projects or the certain activities 226 is recognized and a set of cycle times based on the set of information is estimated. The set of cycle times are used to estimate the set or productivity rates 238.

The scheduling software 212 uses the productivity rates 238 to create the schedule 240. In some embodiments, the schedule 240 exists prior to receiving the productivity rates 238. In these embodiments, the schedule 240 is updated by the scheduling software 212 based on the set of productivity rates 238. In some embodiments, the schedule 240 is updated automatically by the scheduling software 212. In other embodiments, the schedule 240 is updated manually by a user based on the productivity rates 238 through the scheduling software 212. In some embodiments, a total duration of the project or the certain activities 226 is estimated based on the productivity rates 238.

In some embodiments, the computer system 202 sends a notification to a user via the input/output system(s) 206. In some embodiments, the notification indicates a delayed project. In other embodiments, the notification indicates at least one of the heavy equipment in the selected set of heavy equipment is in an idle state. When a piece of heavy equipment is determined to be in an idle state, the heavy equipment can be transferred to a different project or certain activities or removed from the current project and certain activities. When the heavy equipment is removed, the heavy equipment may be added back to the set of available heavy equipment to be selected for other projects or activities. In some embodiments, the notification indicates the failure of a piece of heavy equipment. In yet other embodiments, the notification indicates inefficient use of heavy equipment or an operator operating the heavy equipment.

The following discussion now refers to a number of methods and method acts. Although the method acts are discussed in specific orders or are illustrated in a flow chart as occurring in a particular order, no order is required unless expressly stated or required because an act is dependent on another act being completed prior to the act being performed.

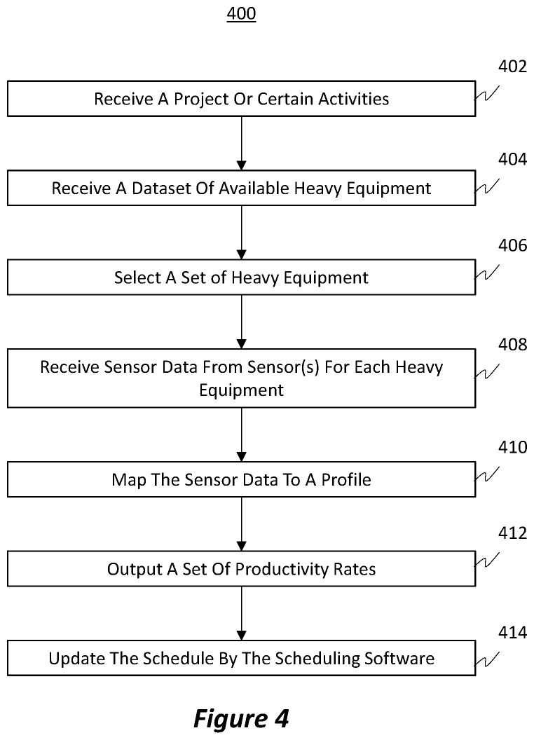

Embodiments are now described in connection with FIG. 4, which illustrates a flow chart of an example method 400 for creating a schedule using the scheduling software 212. In embodiments, instructions for implementing method 400 are encoded as computer-executable instructions stored on a computer storage media (e.g., storage media 220) that are executable by a processor (e.g., processor 204) to cause a computer system (e.g., computer system 202) by a scheduling software 212 to perform method 400.

Referring to FIG. 4, in embodiments, method 400 comprises acts of creating a schedule by a scheduling software. In some embodiments, act 402 comprises receiving a project or certain activities 226. The project or certain activities 226 includes a set of information that describes requirements of the project or certain activities. Referring to act 404, in some embodiments, act 404 comprises receiving a dataset of available heavy equipment 222 associated with the project or certain activities 226.

In embodiments, act 406 comprises selecting a set of heavy equipment 122 from the dataset of available heavy equipment 222. Each heavy equipment (e.g., heavy equipment 104 and heavy equipment 106) in the set of heavy equipment 122 includes at least one sensor (e.g., heavy equipment 104 with sensor 110 and sensor 112 and heavy equipment 106 with sensor 114). In some embodiments, act 408 comprises receiving sensor data 228 from the at least one sensor (e.g., sensor 110, sensor 112, and sensor 114) for each heavy equipment (e.g., heavy equipment 104 and heavy equipment 106) in the set of heavy equipment 122.

In embodiments, act 410 comprises mapping the sensor data 228 to a profile 304. The profile 304 characterizes a machine learning model 306 for at least one heavy equipment (e.g., heavy equipment 104) selected from the set of heavy equipment 122. In some embodiments, act 412 comprises outputting a set of productivity rates 308 for at least a portion of the set of heavy equipment (e.g., heavy equipment 104). In embodiments, act 414 comprises automatically updating the schedule 240 by the scheduling software 212 based on the set of productivity rates 308.

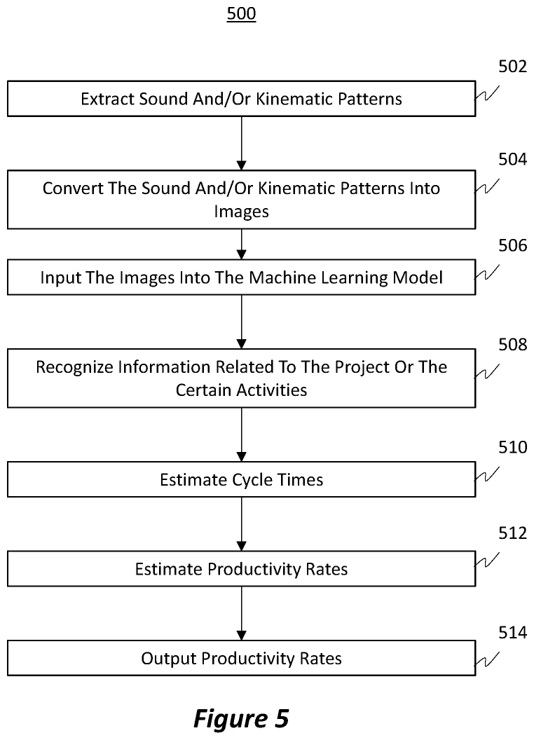

Embodiments are now described in connection with FIG. 5, which illustrates a flow chart of an example method 500 for outputting productivity rates using the machine learning model 306. In embodiments, instructions for implementing method 500 are encoded as computer-executable instructions stored on a computer storage media (e.g., storage media 220) that are executable by a processor (e.g., processor 204) to cause a computer system (e.g., computer system 202) to perform method 500.

Referring to FIG. 5, in embodiments, method 500 comprises acts of outputting productivity rates 308 using a machine learning model 306. In some embodiments, act 502 comprises extracting sound and/or kinematic patterns from the sensor data 302 using a beamforming technique. In embodiments, act 504 comprises pre-processing the sound and/or kinematic patterns for the machine learning model. In some embodiments the sound and/or kinematic patterns are pre-processed by converting the sound and/or kinematic patterns into a set of images using a Short Time Fourier Transform.

In embodiments, act 506 comprises inputting the pre-processed signals into the machine learning model 306. In embodiments, the machine learning model 306 is a convolutional neural network. In some embodiments, act 508 comprises recognizing the set of information related to the project or the certain activities. In embodiments, act 510 comprises estimating a set of cycle times based on the set of information. In some embodiments, act 512 comprises estimating the set of productivity rates 308 based on the set of cycle times. In embodiments, act 514 comprises outputting the set of productivity rates.

Embodiments of the disclosure comprise or utilize a special-purpose or general-purpose computer system (e.g., computer system 202) that includes computer hardware, such as, for example, a processor system (e.g., processor system 204) and system memory (e.g., memory 209), as discussed in greater detail below. Embodiments within the scope of the present disclosure also include physical and other computer-readable media for carrying or storing computer-executable instructions and/or data structures. Such computer-readable media can be any available media accessible by a general-purpose or special-purpose computer system. Computer-readable media that store computer-executable instructions and/or data structures are computer storage media (e.g., storage media 220). Computer-readable media that carry computer-executable instructions and/or data structures are transmission media. Thus, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as random access memory (RAM), read-only memory (ROM), electrically erasable programmable ROM (EEPROM), solid state drives (SSDs), flash memory, phase-change memory (PCM), optical disk storage, magnetic disk storage or other magnetic storage devices, or any other hardware storage device(s) which store program code in the form of computer-executable instructions or data structures, which can be accessed and executed by a general-purpose or special-purpose computer system to implement the disclosed functionality.

Transmission media include a network and/or data links that carry program code in the form of computer-executable instructions or data structures that are accessible by a general-purpose or special-purpose computer system. A “network” is defined as a data link that enables the transport of electronic data between computer systems and other electronic devices. When information is transferred or provided over a network or another communications connection (either hardwired, wireless, or a combination thereof) to a computer system, the computer system may view the connection as transmission media. The scope of computer-readable media includes combinations thereof.

Upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., network interface 207) and eventually transferred to computer system RAM and/or less volatile computer storage media at a computer system. Thus, computer storage media can be included in computer system components that also utilize transmission media.

Computer-executable instructions comprise, for example, instructions and data which when executed at a processor system, cause a general-purpose computer system, a special-purpose computer system, or a special-purpose processing device to perform a function or group of functions. In embodiments, computer-executable instructions comprise binaries, intermediate format instructions (e.g., assembly language), or source code. In embodiments, a processor system comprises one or more central processing units (CPUs), one or more graphics processing units (GPUs), one or more neural processing units (NPUs), and the like.

In some embodiments, the disclosed systems and methods are practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAS, tablets, pagers, routers, switches, and the like. In some embodiments, the disclosed systems and methods are practiced in distributed system environments where different computer systems, which are linked through a network (e.g., by hardwired data links, wireless data links, or by a combination of hardwired and wireless data links), both perform tasks. As such, in a distributed system environment, a computer system may include a plurality of constituent computer systems. Program modules may be located in local and remote memory storage devices in a distributed system environment.

In some embodiments, the disclosed systems and methods are practiced in a cloud computing environment. In some embodiments, cloud computing environments are distributed, although this is not required. When distributed, cloud computing environments may be distributed internally within an organization and/or have components possessed across multiple organizations. In this description and the following claims, “cloud computing” is a model for enabling on-demand network access to a shared pool of configurable computing resources (e.g., networks, servers, storage, applications, and services). A cloud computing model can be composed of various characteristics, such as on-demand self-service, broad network access, resource pooling, rapid elasticity, measured service, and so forth. A cloud computing model may also come in the form of various service models such as Software as a Service (Saas), Platform as a Service (PaaS), Infrastructure as a Service (IaaS), etc. The cloud computing model may also be deployed using different deployment models such as private cloud, community cloud, public cloud, hybrid cloud, etc.

Although the subject matter has been described in language specific to structural features and/or methodological acts, it is to be understood that the subject matter defined in the appended claims is not necessarily limited to the described features or acts described supra or the order of the acts described supra. Rather, the described features and acts are disclosed as example forms of implementing the claims.

The present disclosure may be embodied in other specific forms without departing from its essential characteristics. The described embodiments are only as illustrative and not restrictive. All changes which come within the meaning and range of equivalency of the claims are to be embraced within their scope.

When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset. Unless otherwise specified, the term “subset” excludes the entirety of its superset (i.e., the superset contains at least one item not included in the subset). Unless otherwise specified, a “superset” can include at least one additional element, and a “subset” can exclude at least one element.

1. A computer implemented method, comprising: creating a schedule by a scheduling software, wherein creating the schedule comprises:
receiving a project or certain activities, wherein the project or certain activities includes a set of information that describes requirements of the project or certain activities;
receiving a dataset of available heavy equipment associated with the project or certain activities;
selecting a set of heavy equipment from the dataset of available heavy equipment, wherein each heavy equipment in the set of heavy equipment includes at least one sensor;
receiving sensor data from the at least one sensor for each heavy equipment in the set of heavy equipment;
extracting sound and/or kinematic patterns from the sensor data using a beamforming technique, wherein the beamforming technique comprises a method of spatial filtering or localization of desired sound from a variety of other unwanted sound sources in an environment;
pre-processing the sound and/or kinematic patterns by converting the sound and/or kinematic patterns into a set of images by using a Short Time Fourier Transform;
inputting the set of images into a machine learning model;
estimating, using the machine learning model, a set of cycle times based on the set of information related to the project or the certain activities;
estimating a set of productivity rates based on the set of cycle times;
mapping the sensor data to a profile, wherein the profile characterizes a machine learning model for at least one heavy equipment selected from the set of heavy equipment;
outputting the set of productivity rates for at least a portion of the set of heavy equipment; and
automatically updating the schedule by the scheduling software based on the set of productivity rates.

2. The computer implemented method of claim 1, wherein each heavy equipment in the set of heavy equipment includes two sensors.

3. The computer implemented method of claim 2, wherein a first sensor is a microphone and a second sensor is an accelerometer.

4. The computer implemented method of claim 1, wherein the at least one sensor includes a microphone and an accelerometer.

5. The computer implemented method of claim 1, wherein the sensor data is received by a wireless chipset that is configured to communicate with a microcontroller located within each heavy equipment in the set of heavy equipment.

6. The computer implemented method of claim 5, wherein the communication is established using a serial/parallel interface (SPI) standard.

7. (canceled)

8. (canceled)

9. The computer implemented method of claim 1, wherein the machine learning model is a convolutional neural network.

10. The computer implemented method of claim 1, further comprising:
receiving a set of operators, wherein each operator in the set of operators is assigned to at least one heavy equipment in the set of heavy equipment; and
selecting a portion of operators from the set of operators.

11. The computer implemented method of claim 10, wherein the set of productivity rates is based on the portion of operators.

12. The computer implemented method of claim 1, wherein each heavy equipment in the set of heavy equipment is categorized with an equipment type.

13. The computer implemented method of claim 12, wherein the equipment type includes at least one of standard, wheeled, long-reach, and backhoe excavator.

14. The computer implemented method of claim 1, further comprising estimating a total duration of the project or the certain activities based on the set of productivity rates.

15. The computer implemented method of claim 1, further comprising sending a notification.

16. The computer implemented method of claim 15, wherein the notification indicates a delayed project.

17. The computer implemented method of claim 15, wherein the notification indicates a heavy equipment in the set of heavy equipment is in an idle state.

18. The computer implemented method of claim 1, further comprising:
determining a heavy equipment in the set of heavy equipment is in an idle state; and
transferring the heavy equipment in the set of heavy equipment to a second project or a second set of certain activities.

19. A computer system, comprising:
a processor system; and
a computer storage medium that stores computer-executable instructions that are executable by the processor system to at least:
receive a project or certain activities, wherein the project or certain activities includes a set of information that describes requirements of the project or certain activities;
receive a dataset of available heavy equipment associated with the project or certain activities;
select a set of heavy equipment from the dataset of available heavy equipment, wherein each heavy equipment in the set of heavy equipment includes at least one sensor;
receive sensor data from the at least one sensor for each heavy equipment in the set of heavy equipment;
extract sound and/or kinematic patterns from the sensor data using a beamforming technique, wherein the beamforming technique comprises a method of spatial filtering or localization of desired sound from a variety of other unwanted sound sources in an environment;
pre-process the sound and/or kinematic patterns by converting the sound and/or kinematic patterns into a set of images by using a Short Time Fourier Transform;
input the set of images into a machine learning model;
estimate, using the machine learning model, a set of cycle times based on the set of information related to the project or the certain activities;
estimate a set of productivity rates based on the set of cycle times;
map the sensor data to a profile, wherein the profile characterizes a machine learning algorithm for at least one heavy equipment selected from the set of heavy equipment;
output the set of productivity rates for at least a portion of the set of heavy equipment; and
automatically update a schedule based on the set of productivity rates.

20. A non-transitory computer storage medium that stores computer-executable instructions that are executable by a processor system to create a schedule, the computer-executable instructions including instructions that are executable by the processor system to at least:
receive a project or certain activities, wherein the project or certain activities includes a set of information that describes requirements of the project or certain activities;
receive a dataset of available heavy equipment associated with the project or certain activities;
select a set of heavy equipment from the dataset of available heavy equipment, wherein each heavy equipment in the set of heavy equipment includes at least one sensor;
receive sensor data from the at least one sensor for each heavy equipment in the set of heavy equipment;
extract sound and/or kinematic patterns from the sensor data using a beamforming technique, wherein the beamforming technique comprises a method of spatial filtering or localization of desired sound from a variety of other unwanted sound sources in an environment;
pre-process the sound and/or kinematic patterns by converting the sound and/or kinematic patterns into a set of images by using a Short Time Fourier Transform;
input the set of images into a machine learning model;
estimate, using the machine learning model, a set of cycle times based on the set of information related to the project or the certain activities;
estimate a set of productivity rates based on the set of cycle times;
map the sensor data to a profile, wherein the profile characterizes a machine learning algorithm for at least one heavy equipment selected from the set of heavy equipment;
output the set of productivity rates for at least a portion of the set of heavy equipment; and
automatically update the schedule based on the set of productivity rates.
